(19) United States
(12) Patent Application Publication
(10) Pub. No.: US 2026/0129180 A1
(43) Pub. Date: May 7, 2026

(54) TMP Search Region Harmonization

(71) Applicant: Ofinno, LLC, Reston, VA (US)

(72) Inventor: Damian Ruiz Coll, Reston, VA (US)

(73) Assignee: Ofinno, LLC, Reston, VA (US)

(21) Appl. No.: 19/426,860

(22) Filed: Dec. 19, 2025

Related U.S. Application Data
(63) Continuation of application No. PCT/US2024/035381, filed on Jun. 25, 2024.
(60) Provisional application No. 63/523,412, filed on Jun. 27, 2023.

(51) Int. Cl. H04N 19/105; H04N 19/167; H04N 19/176; H04N 19/593

(52) U.S. Cl. CPC H04N 19/105; H04N 19/167; H04N 19/176; H04N 19/593

(57) ABSTRACT

A video decoder sets all boundaries of a template matching prediction (TMP) search region to align with corresponding boundaries of an intra block copy (IBC) reference region. The video decoder further decodes the current block based on a reference block determined from the TMP search region.

### CROSS-REFERENCE TO RELATED APPLICATIONS

This application is a continuation of International Application No. PCT/US2024/035381, filed Jun. 25, 2024, which claims the benefit of U.S. Provisional Application No. 63/523,412, filed Jun. 27, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17 illustrates an example of template matching prediction (TMP) for predicting a current block (CB) in accordance with embodiments of the present disclosure.

FIG. 18A illustrates an example IBC reference region determined based on an IBC reference sample memory size of 128×128 samples and a CTU size of 128×128 samples in accordance with embodiments of the present disclosure.

FIG. 18B illustrates another example IBC reference region determined based on an IBC reference sample memory size of 128×128 samples and a CTU size of 128×128 samples in accordance with embodiments of the present disclosure.

FIG. 19A illustrates an example IBC reference region determined based on a CTU size of 128×128 samples in accordance with embodiments of the present disclosure.

FIG. 19B illustrates an example IBC reference region determined based on a CTU size of 256×256 samples in accordance with embodiments of the present disclosure.

FIG. 20 illustrates an example IBC reference region determined based on a template matching prediction (TMP) block size.

FIG. 21 illustrates another example IBC reference region relative to a TMP search region determined based on a TMP block size.

FIG. 22 illustrates an example adjusted template matching prediction (TMP) search region determined based on a size of a current block (CB) and an intra block copy (IBC) reference region in accordance with embodiments of the present disclosure.

FIG. 23 illustrates another example adjusted TMP search region determined based on a size of a CB and an IBC reference region in accordance with embodiments of the present disclosure.

FIG. 24 illustrates another example adjusted TMP search region determined based on a size of a CB and an IBC reference region in accordance with embodiments of the present disclosure.

FIG. 25 illustrates a flowchart of a method for determining an adjusted template matching prediction (TMP) search region based on a size of a current block (CB) and an intra block copy (IBC) reference region in accordance with embodiments of the present disclosure.

FIG. 26 illustrates a flowchart of a method for determining a template matching prediction (TMP) search region that is entirely within an intra block copy (IBC) reference region in accordance with embodiments of the present disclosure.

FIG. 27 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications. Video encoding may be used to compress the size of a video sequence to provide for more efficient storage and/or transmission. Video decoding may be used to decompress a compressed video sequence for display and/or other forms of consumption.

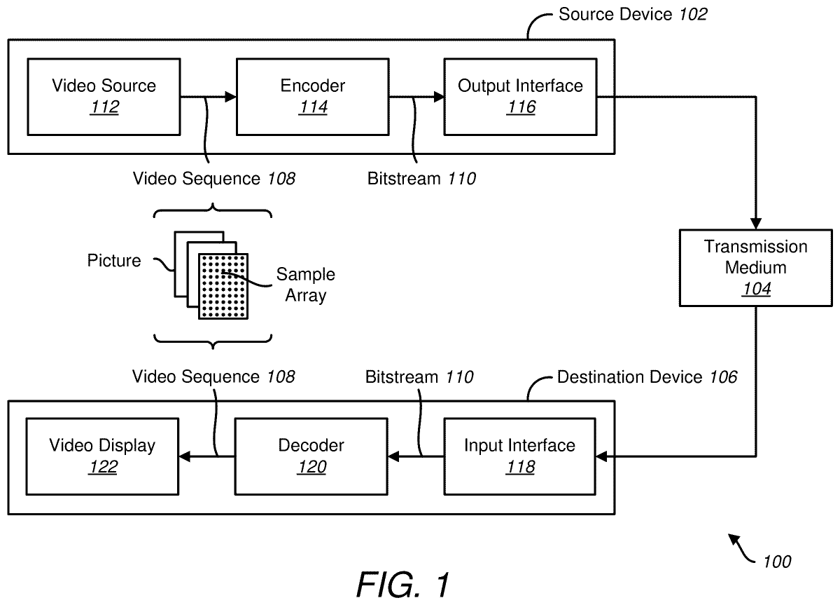

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, liquid crystal display (LCD), a plasma display, light emitting diode (LED) display, or any other display device suitable for displaying video sequence 108.

It should be noted that video encoding/decoding system 100 is presented by way of example and not limitation. In the example of FIG. 1, video encoding/decoding system 100 may have other components and/or arrangements. For example, video source 112 may be external to source device 102. Similarly, video display 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bitstream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC), ITU-T H.265 and MPEG-I Part 3 (also known as Versatile Video Coding (VVC)), the WebM VP8 and VP9 codecs, and AOMedia Video 1 (AV1).

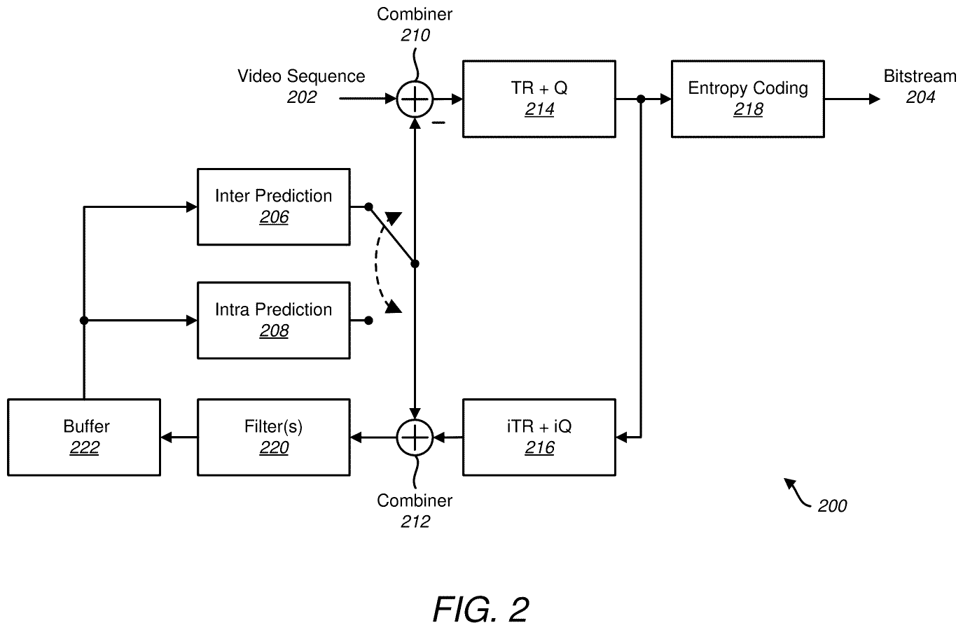

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, The encoder control unit may control the one or more units of encoder 200 such that bitstream 204 is generated in conformance with one or more of ITU-T H.263, AVC, HEVC, VVC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. For example, entropy coding unit 218 may apply context adaptive variable length coding (CAVLC), context adaptive binary arithmetic coding (CABAC), and syntax-based context-based binary arithmetic coding (SBAC) to compress the prediction type used to encode a block (intra or inter prediction), prediction information of the block (intra prediction mode if intra predicted, motion vector, etc.), and transform and quantization parameters. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filters(s) 220.

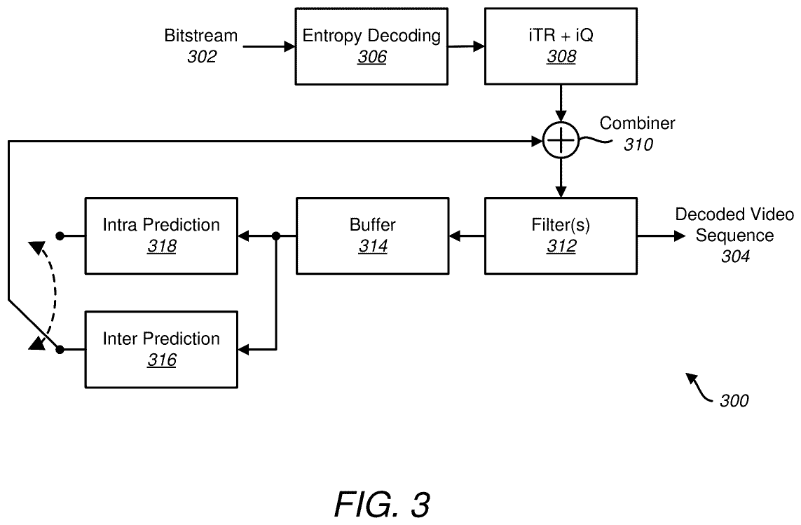

FIG. 3 illustrates an exemplary decoder 300 in which embodiments of the present disclosure may be implemented. Decoder 300 decodes a bitstream 302 into a decoded video sequence 304 for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, The decoder control unit may control the one or more units of decoder 300 such that bitstream 302 is decoded in conformance with one or more of ITU-T H.263, AVC, HEVC, VVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filters(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2n×2n samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode may be applied. For transformations, a CB may be partitioned into one or more transform blocks (TBs). A TB may be a rectangular block of samples that may determine an applied transform size.

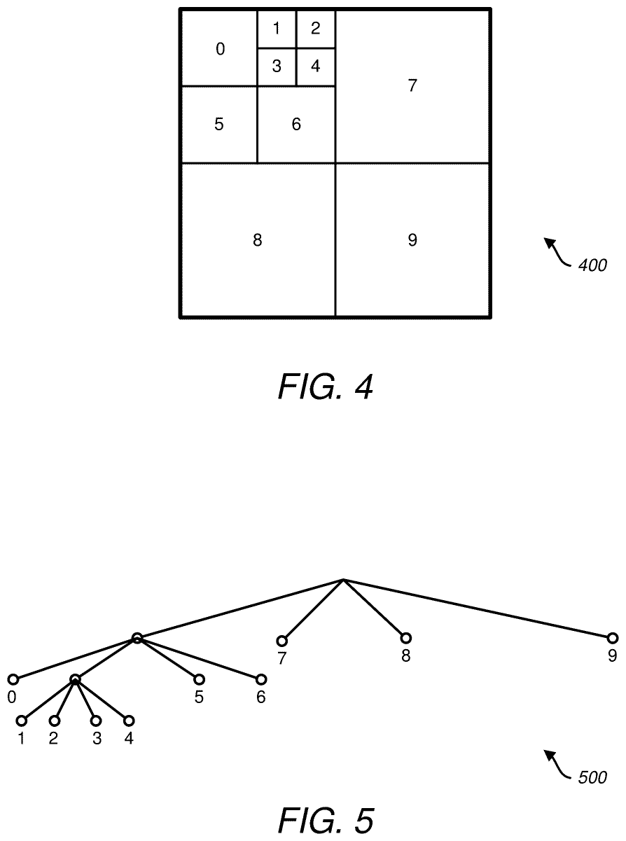

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

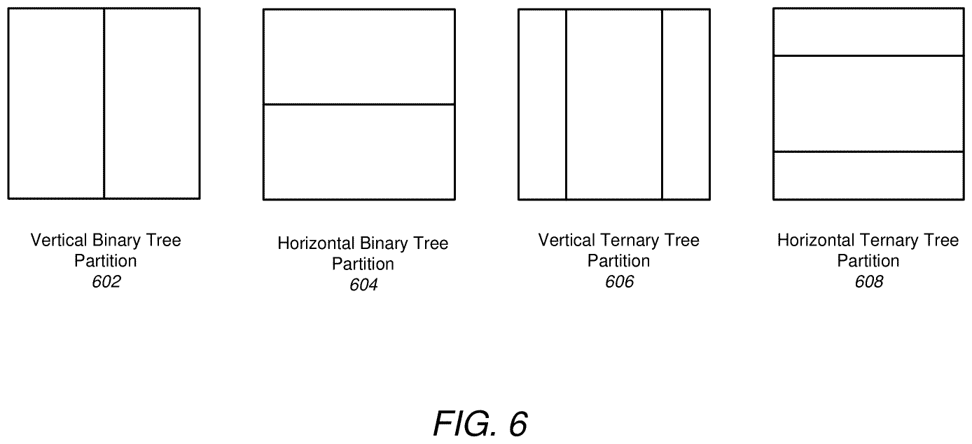

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

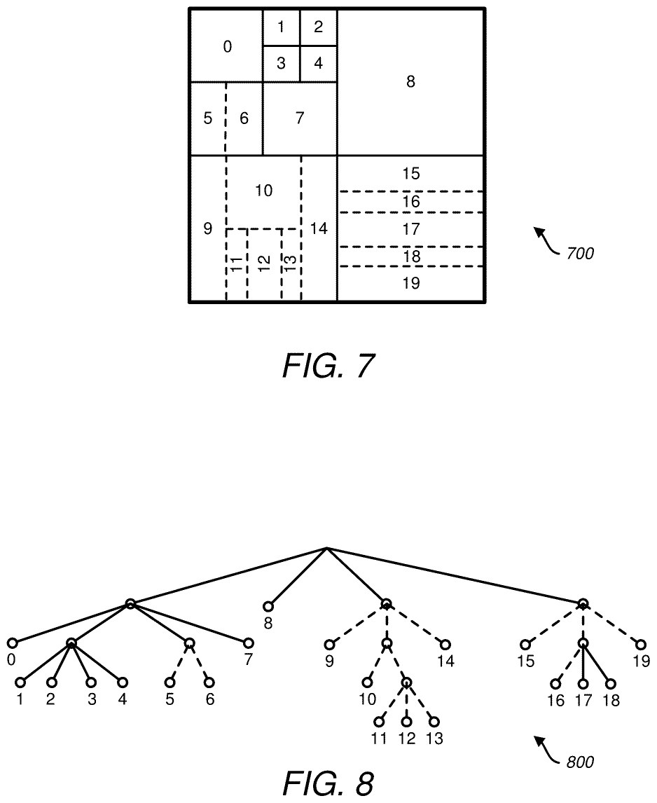

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and VVC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and VVC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

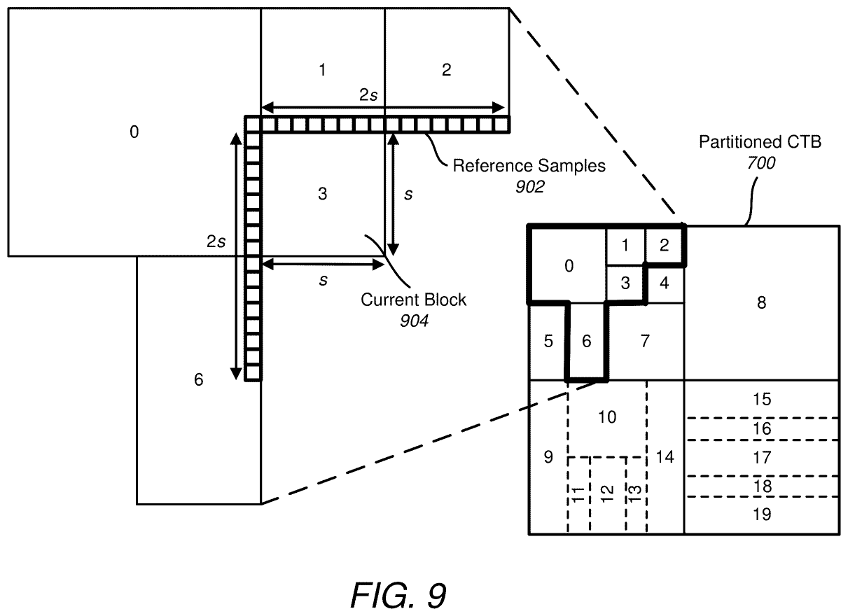

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in VVC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

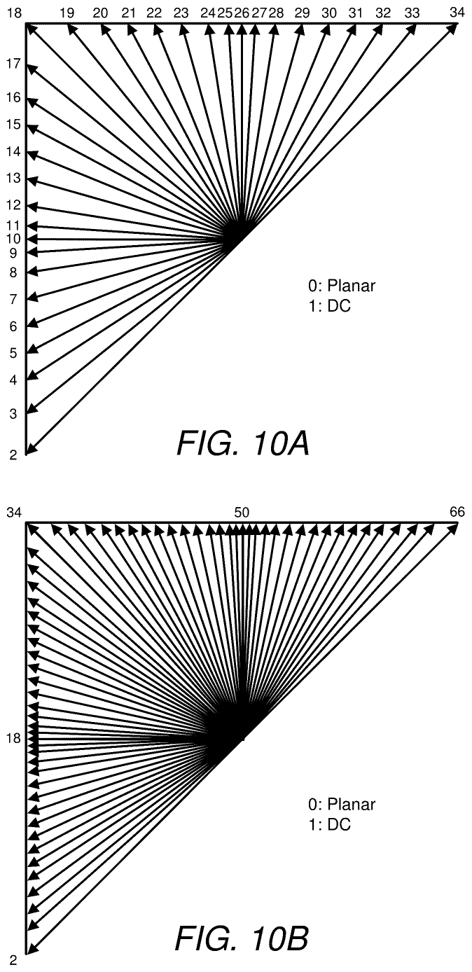

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Because blocks in VVC may be non-square, some of the intra prediction modes illustrated in FIG. 10B may be adaptively replaced by wide-angle directions.

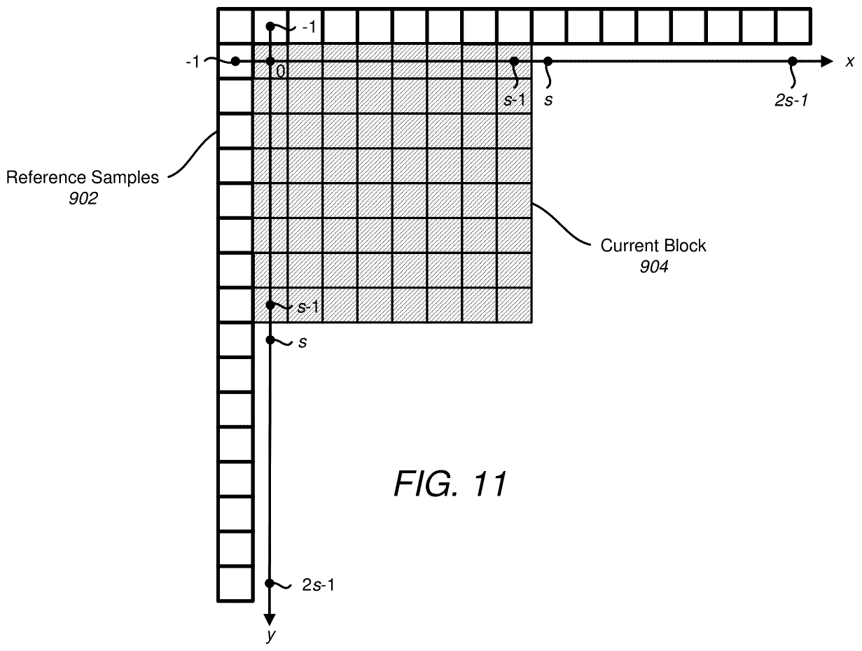

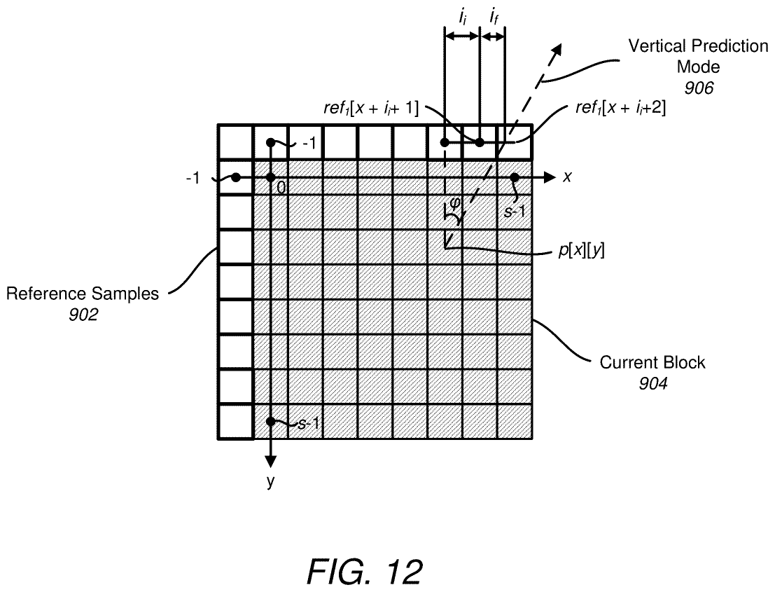

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x][y]. In order to simplify the prediction process, reference samples 902 may be placed in two, one-dimensional arrays. Reference samples 902 above current block 904 may be placed in the one-dimensional array ref₁[x]:

$$\begin{matrix}{ref}_{1} [ x ] = p [ - 1 + x ] [ - 1 ] , & ( x \geq 0 )\end{matrix} \qquad ( 1 )$$

Reference samples 902 to the left of current block 904 may be placed in the one-dimensional array ref₂[x]:

$$\begin{matrix}re {f}_{2} [ y ] = p [ - 1 ] [ - 1 + y ] , & ( y \geq 0 )\end{matrix} \qquad ( 2 )$$

For planar mode, a sample at location [x][y] in current block 904 may be predicted by calculating the mean of two interpolated values. The first of the two interpolated values may be based on a horizontal linear interpolation at location [x][y] in current block 904. The second of the two interpolated values may be based on a vertical linear interpolation at location [x][y] in current block 904. The predicted sample p[x][y] in current block 904 may be calculated as

$$p [ x ] [ y ] = \frac{1}{2 \cdot s} ( h [ x ] [ y ] + v [ x ] [ y ] + s ) \qquad ( 3 )$$

$$where$$

$$h [ x ] [ y ] = ( s - x - 1 ) \cdot re {f}_{2} [ y ] + ( x + 1 ) \cdot re {f}_{1} [ s ] \qquad ( 4 )$$

may be the horizonal linear interpolation at location [x][y] in current block 904 and

$$v [ x ] [ y ] = ( s - y - 1 ) \cdot re {f}_{1} [ x ] + ( y + 1 ) \cdot re {f}_{2} [ s ] \qquad ( 5 )$$

may be the vertical linear interpolation at location [x][y] in current block 904.

For DC mode, a sample at location [x][y] in current block 904 may be predicted by the mean of the reference samples 902. The predicted value sample p[x][y] in current block 904 may be calculated as

$$p [ x ] [ y ] = \frac{1}{2 \cdot s} ( {\sum }_{x = 0}^{s - 1} r e {f}_{1} [ x ] + {\sum }_{y = 0}^{s - 1} r e {f}_{2} [ y ] ) \qquad ( 6 )$$

For angular modes, a sample at location [x][y] in current block 904 may be predicted by projecting the location [x][y] in a direction specified by a given angular mode to a point on the horizontal or vertical line of samples comprising reference samples 902. The sample at location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x][y] in current block 904 for a vertical prediction mode 906 given by an angle @. For vertical prediction modes, the location [x][y] in current block 904 is projected to a point (referred to herein as the “projection point”) on the horizontal line of reference samples ref₁[x]. Reference samples 902 are only partially shown in FIG. 12 for ease of illustration. Because the projection point falls at a fractional sample position between two reference samples in the example of FIG. 12, the predicted sample p[x][y] in current block 904 may be calculated by linearly interpolating between the two reference samples as follows

$$p [ x ] [ y ] = ( 1 - {i}_{f} ) \cdot re {f}_{1} [ x + {i}_{i} + 1 ] + {i}_{f} \cdot re {f}_{1} [ x + {i}_{i} + 2 ] \qquad ( 7 )$$

where iᵢ is the integer part of the horizontal displacement of the projection point relative to the location [x][y] and may calculated as a function of the tangent of the angle φ of the vertical prediction mode 906 as follows

$${i}_{i} = ⌊ ( y + 1 ) \cdot tan φ ⌋ , \qquad ( 8 )$$

and i_{f} is the fractional part of the horizontal displacement of the projection point relative to the location [x][y] and may be calculated as

$${i}_{f} = ( ( y + 1 ) \cdot tan φ ) - ⌊ ( y + 1 ) \cdot tan φ ⌋ . \qquad ( 9 )$$

where └⋅┘ is the integer floor.

For horizontal prediction modes, the position [x][y] of a sample in current block 904 may be projected onto the vertical line of reference samples ref₂[y]. Sample prediction for horizontal prediction modes is given by:

$$p [ x ] [ y ] = ( 1 - {i}_{f} ) \cdot re {f}_{2} [ y + {i}_{i} + 1 ] + {i}_{f} \cdot re {f}_{2} [ y + {i}_{i} + 2 ] \qquad ( 10 )$$

where iᵢ is the integer part of the vertical displacement of the projection point relative to the location [x][y] and may be calculated as a function of the tangent of the angle φ of the horizontal prediction mode as follows

$${i}_{i} = ⌊ ( x + 1 ) \cdot tan φ ⌋ , \qquad ( 11 )$$

and i_{f} is the fractional part of the vertical displacement of the projection point relative to the location [x][y] and may be calculated as

$${i}_{f} = ( ( x + 1 ) \cdot tan φ ) - ⌊ ( x + 1 ) \cdot tan φ ⌋ . \qquad ( 12 )$$

where └⋅┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1−i_{f}) and i_{f}. In the above angular intra prediction examples, the predicted sample p[x][y] may be calculated with some predefined level of sample accuracy, such as 1/32 sample accuracy. For 1/32 sample accuracy, the set of two-tap FIR interpolation filters may comprise up to 32 different two-tap FIR interpolation filters-one for each of the 32 possible values of the fractional part of the projected displacement i_{f}. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on i_{f}, similar to the two-tap FIR filter. For 1/32 sample accuracy, a set of 32 different four-tap FIR filters may comprise up to 32 different four-tap FIR filters-one for each of the 32 possible values of the fractional part of the projected displacement i_{f}. In other examples, different levels of sample accuracy may be used. The set of four-tap FIR filters may be stored in a look-up table (LUT) and referenced based on i_{f}. The value of the predicted sample p [x][y], for vertical prediction modes, may be determined based on the four-tap FIR filter as follows:

$$p [ x ] [ y ] = {\sum }_{i = 0}^{3} fT [ i ] * r e f [ x + iIdx + i ] \qquad ( 13 )$$

where fT[i], i=0 . . . 3, are the filter coefficients. The value of the predicted sample p[x][y], for horizontal prediction modes, may be determined based on the four-tap FIR filter as follows:

$$p [ x ] [ y ] = {\sum }_{i = 0}^{3} fT [ i ] * r ef [ y + iIdx + i ] . \qquad ( 14 )$$

It should be noted that supplementary reference samples may be constructed for the case where the position [x][y] of a sample in current block 904 to be predicted is projected to a negative x coordinate, which happens with negative vertical prediction angles q. The supplementary reference samples may be constructed by projecting the reference samples in ref₂[y] in the vertical line of reference samples 902 to the horizontal line of reference samples 902 using the negative vertical prediction angle φ. Supplemental reference samples may be similarly for the case where the position [x][y] of a sample in current block 904 to be predicted is projected to a negative y coordinate, which happens with negative horizontal prediction angles φ. The supplementary reference samples may be constructed by projecting the reference samples in ref₁[x] on the horizontal line of reference samples 902 to the vertical line of reference samples 902 using the negative horizontal prediction angle φ.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction mode as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

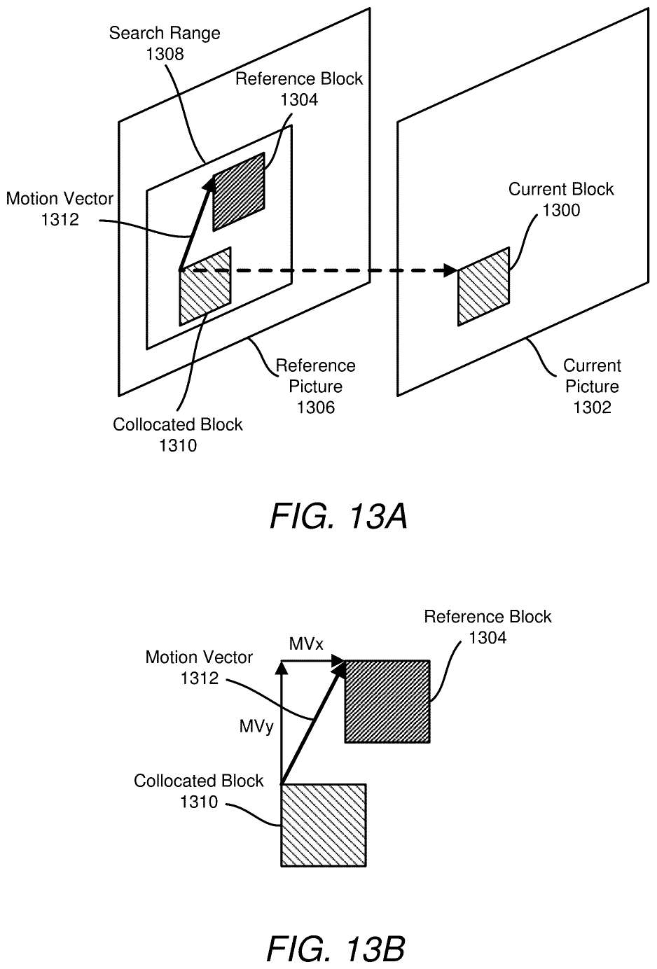

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of a candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have ½, ¼, ⅛, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

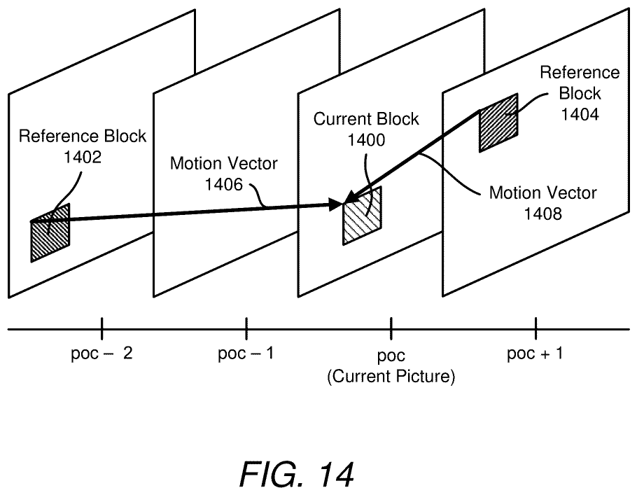

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1402 is in a picture that proceeds the current picture of current block 1400 in terms of POC. In other examples, the reference pictures may both precede or proceed the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index, into the reference picture list, of the reference picture comprising reference block 1402. In other instances, the motion information for reference block 1402 may include an indication of motion vector 1406 and an indication of the reference index, into the reference picture list, of the reference picture comprising reference block 1402. The motion information for reference block 1404 may include motion vector 1408 and the reference index, into the reference picture list, of the reference picture comprising reference block 1404. In other instances, the motion information for reference block 1404 may include an indication of motion vector 1408 and an indication of the reference index, into the reference picture list, of the reference picture comprising reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bitstream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. For example, for a motion vector represented by a horizontal component (MVx) and a vertical displacement (MVy) relative to the position of the current block being coded, the MVD may be represented by two components calculated as follows:

$$M V {D}_{x} = M {V}_{x} - M V {P}_{x} \qquad ( 15 )$$

$$MV {D}_{y} = M {V}_{y} - M V {P}_{y} \qquad ( 16 )$$

where MVDₓ and MVD_{y} respectively represent the horizontal and vertical components of the MVD, and MVPₓ and MVP_{y} respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

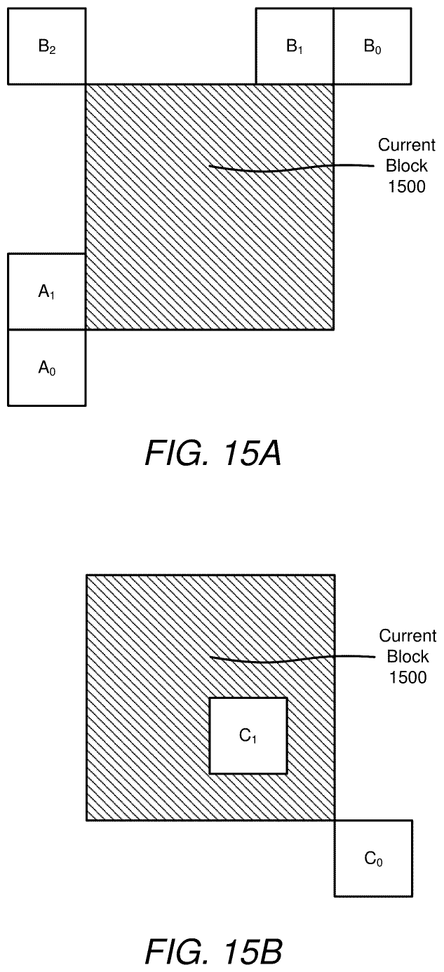

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bitstream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and VVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

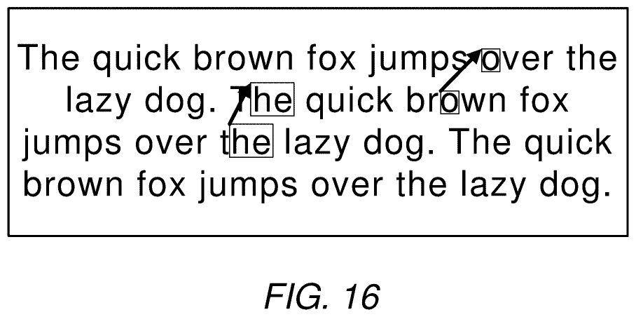

HEVC and VVC both include a prediction technique to exploit the correlation between blocks of samples within the same picture of screen content video. This technique is referred to as intra block copy (IBC) or current picture referencing (CPR). Similar to inter prediction, an encoder may apply a block matching technique to determine a displacement vector (referred to as a block vector (BV)) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bitstream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may represented by two components calculated as follows:

$$B V {D}_{x} = B {V}_{x} - B V {P}_{x} \qquad ( 17 )$$

$$BV {D}_{y} = B {V}_{y} - B V {P}_{y} \qquad ( 18 )$$

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂.

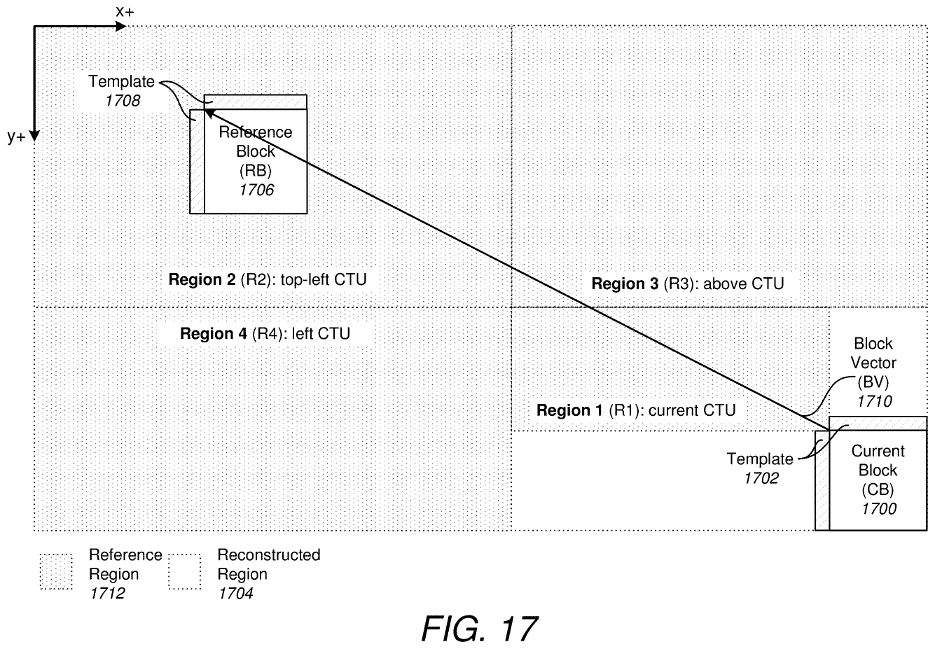

FIG. 17 illustrates an example of template matching prediction (TMP) for predicting a current block (CB) in accordance with embodiments of the present disclosure. Template matching prediction (TMP) is a prediction method that may be implemented by an encoder and decoder. In TMP, a reconstructed region may be searched for a template of a reference block (RB) that matches a template of a current block (CB). The template of the RB indicates a location of the RB in the reconstructed region, and the RB at this location may be used to predict the CB.

FIG. 17 further illustrates an example of TMP for predicting a current block (CB) 1700. CB 1700 comprises a rectangular block of samples to be encoded by an encoder. To perform TMP for predicting CB 1700, the encoder may determine or construct a template 1702 of CB 1700. The encoder may determine or construct template 1702 based on samples in a reconstructed region 1704. In an example, template 1702 may comprise samples in reconstructed region 1704 that are adjacent to the samples of CB 1700. For example, template 1702 may comprise samples in reconstructed region 1704 to the left and/or above CB 1700.

After determining or constructing template 1702 of CB 1700, the encoder may search reconstructed region 1704 for a template of a reference block (RB) (e.g., RB 1706) that is determined to match template 1702 of CB 1700. The encoder may search reconstructed region 1704 for a template of an RB that matches template 1702 of CB 1700 by determining a cost between template 1702 and one or more templates of one or more reference blocks (RBs) in reconstructed region 1704. In an example, the cost may be based on a difference (e.g., sum of squared differences (SSD), sum of absolute differences (SAD), sum of absolute transformed differences (SATD), or difference determined based on a hash function) between a template of an RB and template 1702 of CB 1700. In the example illustrated by FIG. 17, template 1708 of RB 1706 is determined to match template 1702 of CB 1700 (e.g., based on the cost between template 1702 of CB 1700 and template 1708 of RB 1706). A block vector (BV) (e.g., BV 1710) may indicate the displacement of an RB (e.g., RB 1706) relative to a CB (e.g., CB 1700).

After determining that template 1708 of RB 1706 matches template 1702 of CB 1700, the encoder may use RB 1706 to predict CB 1700. For example, the encoder may determine a difference (e.g., a corresponding sample-by-sample difference) between CB 1700 and RB 1706. The difference may be referred to as a prediction error or residual. The encoder may store and/or signal in a bitstream the prediction error or residual for decoding by a decoder.

To perform TMP for predicting CB 1700, a decoder may perform the same operations as the encoder as described above with respect to FIG. 17. For example, based on receiving an indication from the encoder that TMP is used to predict CB 1700 (e.g., via a syntax element or flag), the decoder may similarly determine or construct template 1702 of CB 1700. After determining or constructing template 1702, the decoder may further similarly search reconstructed region 1704 for a template of an RB that is determined to match template 1702 of CB 1700. For example, the decoder may determine that template 1708 of RB 1706 matches template 1702 of CB 1700. After determining that template 1708 of RB 1706 matches template 1702 of CB 1700, the decoder may use RB 1706 to predict CB 1700. The decoder may combine the residual received from the encoder with RB 1706 to reconstruct CB 1700.

FIG. 17 also illustrates an example reference region 1712. Reference region 1712 comprises a portion of reconstructed region 1704. Reference region 1712 indicates the regions that the encoder or decoder may search for one or more matching templates of RBs for template 1702 of CB 1700. Reference region 1712 may include four regions. Relative to CB 1700, region 1 (R1) is the current CTU, region 2 (R2) is the top-left CTU, region 3 (R3) is the above CTU, and region 4 (R4) is the left CTU. The CTUs are a result of picture partitioning operations described in more detail above. For example, an encoder or decoder may search for a matching template within reference region 1712, i.e., within each of R1, R2, R3, and R4. For example, template 1708 of RB 1706 may be determined to match template 1702 of CB 1700 based on a SAD cost or some other cost as described above. The decoder may use RB 1706 to predict CB 1700 as described above.

Further, in practice, the dimensions of reference region 1712 (referred to as SearchRange_w, SearchRange_h) may be set proportionally to the dimensions of CB 1700 (referred to as BlkW, BlkH), for example, in order to have a fixed number of SAD comparisons (or other difference comparisons) per pixel. More specifically, the dimensions of reference region 1712 may be calculated as follows:

$$SearchRange\_w = a * BlkW \qquad ( 19 )$$

$$SearchRange\_h = a * BlkH \qquad ( 20 )$$

where ‘a’ (or alpha) is a constant that controls a gain/complexity trade-off for the encoder or decoder. In practice, ‘a’ may be equal to 5. In FIG. 17, it should further be noted that the dimensions of the regions of reference region 1712, as well as reconstructed region 1704, are illustrated by example and not by limitation. In practice, for example, the dimensions of the regions may vary, and one or more of the regions may not be present. In the example illustrated by FIG. 17, portions of reconstructed region 1704 directly above and directly left of CB 1700 may not be available for prediction and are thus excluded from reference region 1712. For example, this may be because an RB in these portions would overlap with CB 1700, which would be an invalid location for prediction of CB 1700. A similar restriction may also be based on the unavailability of samples because of the sequence order of encoding or decoding, or because the samples may be outside of the reference region or the current picture.

In HEVC and VVC, intra block copy (IBC) is a type of predictive coding that may be implemented by an encoder and decoder. For example, an encoder, such as encoder 200 in FIG. 2, may use an IBC prediction mode to code a current block in a current picture (or portion of a current picture). A current block may also be referred to as a coding block within a coding tree unit (CTU). Unlike inter prediction that searches for a reference block in a prior decoded picture that is different than the picture of the current block being encoded, IBC searches for a reference block in the same, current picture as the current block. As a result, only part of the current picture may be available for searching for a reference block in IBC, for example, only the part of the current picture that has been decoded prior to the encoding of the current block. This may ensure the encoding and decoding systems can produce identical results but also limits the IBC reference region.

In an example, intra block copy (IBC) prediction information, e.g., a block vector predictor (BVP) and a block vector difference (BVD), may be signaled in a bitstream by an encoder and extracted from a bitstream by a decoder in order to decode a block vector (BV) for reconstructing a current block. For example, the encoder may signal, in a bitstream, the prediction error, an indication of a selected BVP (e.g., via an index pointing into a list of candidate BVPs, such as an AMVP list), the separate horizontal and vertical components of a BVD, as well as a sign of each of the separate horizontal and vertical components of the BVD. The decoder may decode the BV by adding the corresponding horizontal and vertical components of the BVD to the corresponding components horizontal and vertical components of the BVP. The decoder may decode a current block by determining a reference block, which forms the prediction of the current block, using the decoded BV and combining the prediction with the prediction error received in the bitstream.

In HEVC, VVC, and other video compression standards, blocks may be scanned from left-to-right, top-to-bottom using a z-scan to form the sequence order for encoding/decoding. Based on the z-scan, the CTUs to the left and in the row immediately above a current CTU may be encoded/decoded prior to a current CTU and a current block. Therefore, the samples of these CTUs may form an exemplary IBC reference region for determining a reference block to predict a current block. In other video encoders and decoders, a different sequence order for encoding/decoding may be used, which may influence an IBC reference region accordingly.

In addition to the encoding/decoding sequence order, one or more additional reference region constraints may be placed based on an IBC reference region. For example, an IBC reference region may be constrained to CTUs based on a parallel processing approach, like tiles or wavefront parallel processing (WPP). Tiles may be used as part of a picture partitioning process for flexibly subdividing a picture into rectangular regions of CTUs such that coding dependencies between CTUs of different tiles are not allowed. WPP may be similarly used as part of a picture partitioning process for partitioning a picture into CTU rows such that dependencies between CTUs of different partitions are not allowed. Each of these tools may enable parallel processing of the picture partitions. The top row of CTUs may not be part of the IBC reference region due to one of these parallel processing approaches.

For example, in addition to being constrained to a reconstructed part of a current picture and potentially to a particular wavefront parallel processing (WPP) partition or tile partition as mentioned above, an IBC reference region may be further constrained to include a number of decoded or reconstructed samples that may be stored in a limited size IBC reference sample memory. The size of the IBC reference sample memory may be limited based on being implemented on-chip with the encoder or decoder. The IBC reference region may be increased in size by using a larger size IBC reference sample memory off-chip from the encoder or decoder; however, such an approach may have its own drawbacks, such as increased off-chip memory bandwidth requirements and increased delay in writing and reading samples in the IBC reference region to and from the IBC reference sample memory.

In an embodiment, with a limited size IBC reference sample memory, the IBC reference region may be constrained to: a reconstructed part of the current CTU; and one or more reconstructed CT Us to the left of the current CTU not including a portion, of a left most one of the one or more reconstructed CTUs, collocated with either the reconstructed part of the current CTU or a virtual pipeline data unit (VPDU) in which the current block being coded is located. Blocks of samples in different CTUs may be collocated based on having a same size and CTU offset. A CTU offset of a block may be the offset of the block's top-left corner relative to the top-left corner of the CTU in which the block is located.

The IBC reference region may not include the portion, of the left most one of the more reconstructed CTUS, that is collocated with the reconstructed part of the current CTU because the IBC reference sample memory may be implemented similarly to a circular buffer. For example, the IBC reference sample memory may store reconstructed reference samples corresponding to one or more CTUs. Once the IBC reference sample memory is filled, reconstructed reference samples of the current CTU may replace the reconstructed reference samples of a CTU stored in the IBC reference sample memory that are located, within a picture or frame, farthest to the left of the current CTU. The samples of the CTU stored in the IBC reference sample memory that are located, within a picture or frame, farthest to the left of the current CTU may correspond to the oldest data in the IBC reference sample memory. This update mechanism allows some of the reconstructed reference samples from the left most CTU to remain stored in the IBC reference sample memory when processing the current CTU. The remaining reference samples of the left most CTU stored in the IBC reference sample memory may then be used for predicting the current block in the current CTU.

In addition, in typical hardware implementations of an encoder or decoder, a CTU may not be processed all at once. Instead, the CTU may be divided into VPDUs for processing by a pipeline stage. A VPDU may comprise a 4×4 region of samples, a 16×16 region of samples, a 32×32 region of samples, a 64×64 region of samples, a 128×128 region of samples, or some other sample region size. In an embodiment, a size of a VPDU may be determined based on a minimum of a maximum VPDU size (e.g., a 64×64 region of samples) and a size (e.g., a width or height) of a current CTU. The portion of the left most one of the one or more reconstructed CTUs that is collocated with the VPDU in which the block being coded is located may be further excluded from the IBC reference region as mentioned above. By excluding this region of the left most one of the one or more reconstructed CTUs from the IBC reference region, the corresponding portion of the IBC reference sample memory used to store reconstructed reference samples from this region may be used to store only samples within the region of the current CTU corresponding to the VPDU, which may avoid certain complexities in design.

The number of reconstructed CTUs to the left of the current CTU included in the IBC reference region may be determined based on the number of reconstructed reference samples the IBC reference sample memory may store and the size of the CTUs in the current picture. For example, the number of reconstructed CTUs to the left of the current CTU included in the IBC reference region may be determined based on the number of reconstructed reference samples the IBC reference sample memory may store divided by the size of a CTU in the current picture. Thus, for an IBC reference sample memory that may store 128×128 reconstructed reference samples for the IBC reference region and a CTU size of 128×128 samples, the number of reconstructed CTUs to the left of the current CTU included in the IBC reference region may be equal to (128×128)/(128×128) or 1 CTU. In another example, for a memory that may store 128×128 reconstructed reference samples for the IBC reference region and a CTU size of 64×64 samples, the number of reconstructed CTUs to the left of the current CTU included in the IBC reference region may be equal to (128×128)/(64×64) or 4 CTUs.

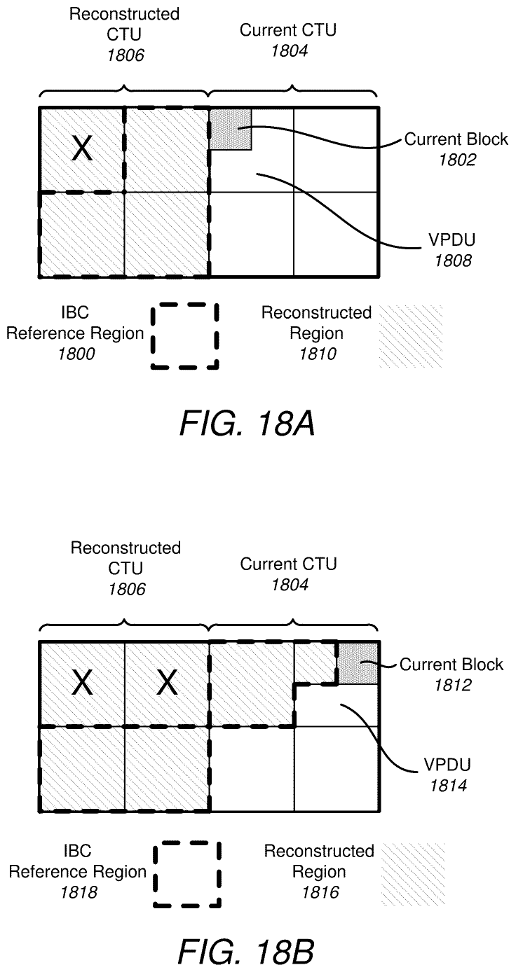

FIG. 18A illustrates an example IBC reference region determined based on an IBC reference sample memory size of 128×128 samples and a CTU size of 128×128 samples in accordance with embodiments of the present disclosure. Based on the IBC reference sample memory size of 128×128 samples and a CTU size of 128×128 samples, the number of reconstructed CTUs to the left of the current CTU included in the IBC reference region may be equal to (128×128)/(128×128) or 1 CTU.

FIG. 18A further illustrates a current block 1802 within a current CTU 1804. Current block 1802 is the first block coded in current CTU 1804 and is coded using IBC mode. As described above, a block may be coded using IBC mode by determining a matching, or “best matching”, reference block within an IBC reference region. In FIG. 18A, IBC reference region 1800 may be constrained to: a reconstructed part of current CTU 1804; and the single, reconstructed CTU 1806 to the left of current CTU 1804 not including a portion, of reconstructed CTU 1806, collocated with either the reconstructed part of current CTU 1804 or a virtual pipeline data unit (VPDU) 1808 in which current block 1802 is located. In the example of FIG. 18A, CTUs are divided into 4 VPDUs of size 64×64 samples. Accordingly, IBC reference region 1800 for current block 1802 includes reconstructed region 1810 (shown with hatching) except the 64×64 region of reconstructed CTU 1806 collocated with VPDU 1808. This collocated region is marked with an “X” in FIG. 18A. It should be noted that, for different size CTUs, the IBC reference region in FIG. 18A may include a different number of CTUs to the left of current CTU 1804 than the single, reconstructed CTU 1806. For example, for CTU sizes of 64×64, the IBC reference region may include 4 CTUs to the left of current CTU 1804 based on the number of reconstructed reference samples the IBC reference sample memory may store divided by the size of the CTUs in the current picture.

FIG. 18B illustrates another example IBC reference region determined based on an IBC reference sample memory size of 128×128 samples and a CTU size of 128×128 samples in accordance with embodiments of the present disclosure. FIG. 18B continues with the example of FIG. 18A for a later coded block in current CTU 1804 in accordance with embodiments of the present disclosure. The later coded block is labeled as current block 1812 in FIG. 18B and is coded using IBC mode by determining a matching, or “best matching”, reference block within an IBC reference region. IBC reference region 1818 for current block 1812 may be constrained to: a reconstructed part of current CTU 1804; and the reconstructed CTU 1806 not including a portion, of reconstructed CTU 1806, collocated with either the reconstructed part of current CTU 1804 or a virtual pipeline data unit (VPDU) 1814 in which current block 1812 is located. As mentioned above with respect to FIG. 18A, current CTU 1804 is divided into 4 VPDUs of size 64×64 samples. Accordingly, IBC reference region 1818 in FIG. 18B for current block 1812 includes reconstructed region 1816 (shown with hatching) except the part of CTU 1806 collocated with either the reconstructed part of current CTU 1804 or VPDU 1814. These collocated regions are each marked with an “X” in FIG. 18B.

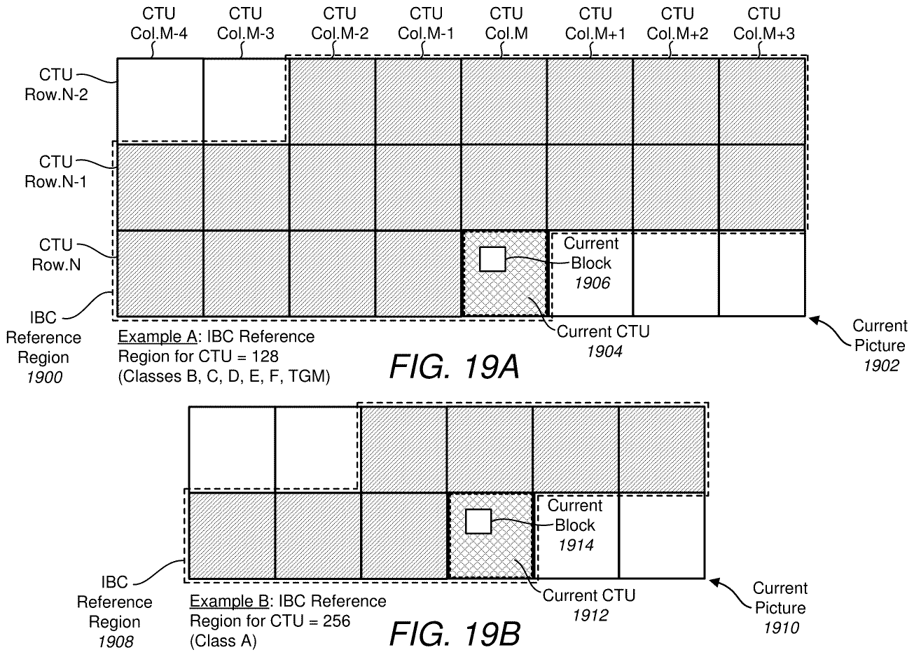

FIG. 19A illustrates an example IBC reference region determined based on a CTU size of 128×128 samples in accordance with embodiments of the present disclosure. In an example, modifications to existing approaches for IBC reference regions were introduced into the Enhanced Compression Model (ECM) software algorithm that is currently under coordinated exploration study by the Joint Video Exploration Team (JVET) of ITU-T Video Coding Experts Group (VCEG) and ISO/IEC MPEG as a potential enhanced video coding technology beyond the capabilities of VVC. In an example, each coding transform unit (CTU) may use a size of 128×128 samples for video sequence types of Class B, C, D, E, F, and TGM as indicated in common testing condition parameters in ECM. In another example, each coding transform unit (CTU) may use a size of 256×256 samples for video sequence types of Class A as indicated in common testing condition parameters in ECM. These video sequence types may indicate or be associated with different video content types (e.g., natural content or screen-captured content) and different video content resolutions (e.g., non-4K or 4K resolution).

FIG. 19A further illustrates an example of an IBC reference region 1900 based on a CTU size of 128×128 samples for a current picture 1902. Example A of IBC reference region 1900 corresponds to a CTU size of 128×128 samples for video sequence types of Class B, C, D, E, F, and TGM. Current picture 1902 comprises a plurality of CTUs (indicated by squares), and hatching indicates that the CTUs are available for prediction as part of IBC reference region 1900 (having boundaries indicated by dashed lines). As illustrated in FIG. 19A, IBC reference region 1900 comprises a plurality of columns and rows of samples. Relative to a current CTU 1904 including a current block 1906, IBC reference region 1900 includes three rows-denoted as CTU Row.N, CTU Row. N−1, and CTU Row.N−2—and a plurality of columns, denoted as CTU Col.M−4 through CTU Col.M+3. The rows and columns of available CTUs comprising IBC reference region 1900 may be dynamic, for example, as blocks are encoded, the size and shape of IBC reference region 1900 may change.

FIG. 19B illustrates an example IBC reference region determined based on a CTU size of 256×256 samples in accordance with embodiments of the present disclosure. FIG. 19B further illustrates an example of an IBC reference region 1908 based on a CTU size of 256×256 samples for a current picture 1910. Example B of IBC reference region 1908 corresponds to a CTU size of 256×256 samples for a video sequence type of Class A (e.g., a video sequence with a 4K resolution). Current picture 1910 comprises a plurality of CTUs (indicated by squares), and hatching indicates that the CTUs are available for prediction as part of IBC reference region 1908 (having boundaries indicated by dashed lines). As illustrated in FIG. 19B, IBC reference region 1908 comprises a plurality of columns and rows of samples relative to a current CTU 1912 including a current block 1914. IBC reference region 1908 comprises two rows and six columns, fewer than IBC reference region 1900 of FIG. 19A, based on, e.g., the comparatively larger CTU size of 256×256 samples. The rows and columns of available CTUs comprising IBC reference region 1908 may be dynamic, for example, as blocks are encoded, the size and shape of IBC reference region 1908 may change.

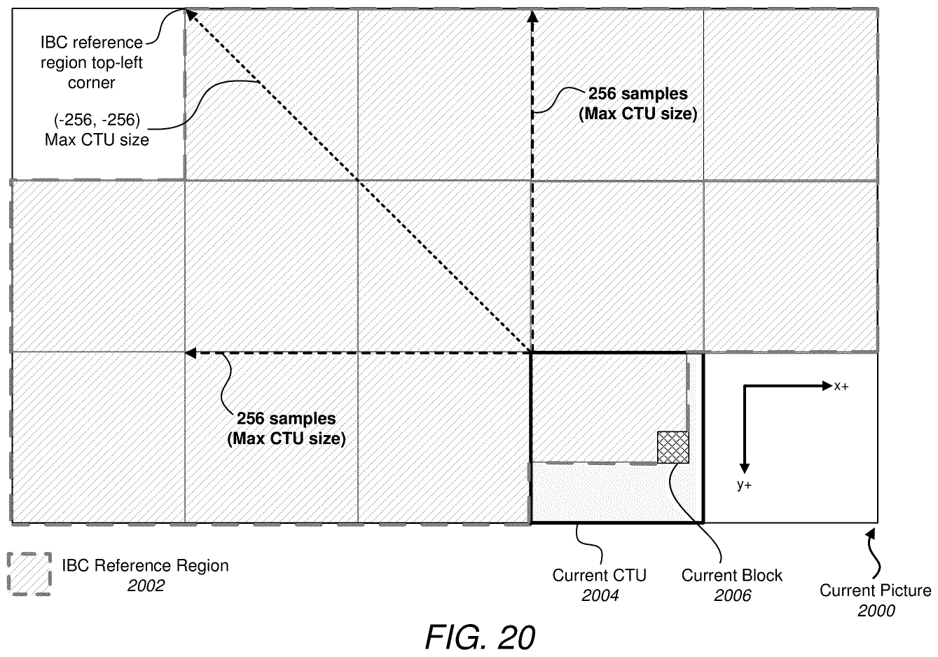

FIG. 20 illustrates an example IBC reference region determined based on a template matching prediction (TMP) block size. For TMP, the largest block size may be equal to 64×64 samples. As illustrated in FIG. 20, current picture 2000 comprises a plurality of CTUs (indicated by squares), and hatching indicates that the CTUs are available for prediction as part of an IBC reference region 2002 (having boundaries indicated by dashed lines). Further, as illustrated in FIG. 20, IBC reference region 2002 comprises a plurality of columns and rows of samples relative to a current CTU 2004 including a current block 2006. In an example, when a 64×64 block of samples is encoded using a prediction mode related to intra prediction for TMP (also referred to as IntraTMP), a maximum CTU size may correspond to 256 samples to the left and above current CTU 2004 that includes current block 2006 (as indicated by dashed arrows in FIG. 20). Further, a top-left corner of IBC reference region 2002 may be indicated by the maximum CTU size (−256, −256) illustrated by the directional dashed arrows in FIG. 20. The rows and columns of available CTUs comprising IBC reference region 2002 may be dynamic, for example, as blocks are encoded, the size and shape of IBC reference region 2002 may change.

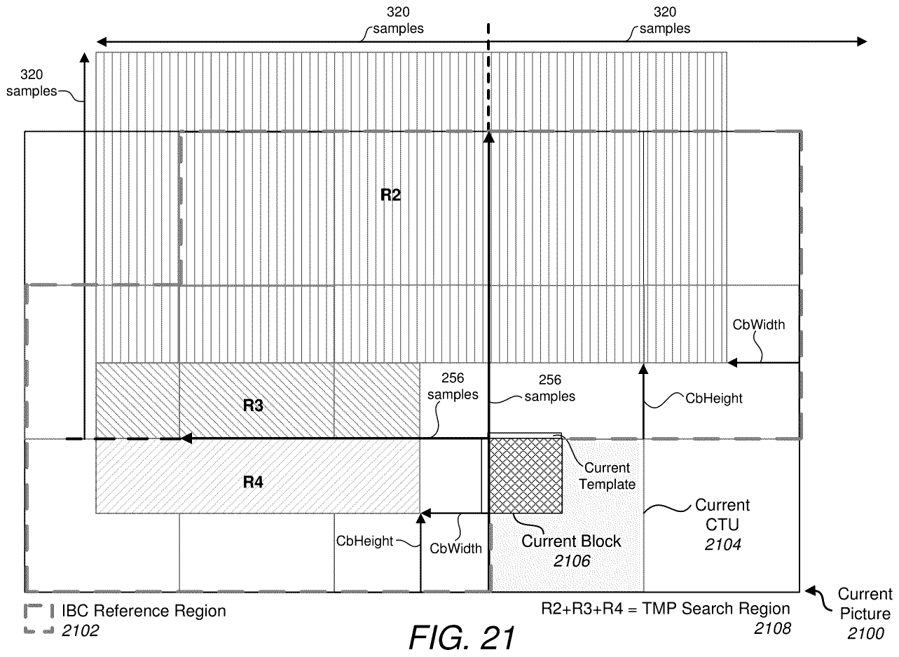

FIG. 21 illustrates another example IBC reference region relative to a TMP search region determined based on a TMP block size. As illustrated in FIG. 21, current picture 2100 comprises a plurality of CTUs (indicated by squares) that are part of an IBC reference region 2102, wherein the boundaries of IBC reference region 2102 are indicated by dashed lines. Further, as illustrated in FIG. 21, IBC reference region 2102 comprises a plurality of columns and rows of samples relative to a current CTU 2104 including a current block 2106.

As discussed above, for TMP, the largest block size, such as a size of a current block or reference block, may be equal to 64×64 samples. Further, a TMP search region may be based on a multiple of the TMP block size such as a multiple of 5 of the 64 samples (320 samples total), in a horizontal direction and a vertical direction. As illustrated in FIG. 21, a TMP search region 2108 may be based on a combination of regions denoted as R2, R3, and R4. In the example illustrated by FIG. 21, the region R2 is 320 pixels to the left, right, and top of current CTU 2104 comprising current block 2106. Further, as illustrated by FIG. 21, the top-left corner of the R2 region is shifted (−320, −320) samples with respect to the top-left corner of CTU 2104. Further, as illustrated in FIG. 21, the right side of the R2 region is constrained to the right side of the boundary of current picture 2100. In other examples, more CTUs may be located to the right of current CTU 2104. Further, as illustrated in FIG. 21, the boundaries of the regions R2, R3, and R4 of TMP search region 2108 may be offset by a dimension of current block 2106 from the boundaries of IBC reference region 2102, such that the regions R2, R3, and R4 indicate boundaries for valid locations of TMP block vectors (BVs) indicating reference blocks for the current block. In an example, the dimension may be a width or a height of current block 2106. The rows and columns of available CTUs comprising IBC reference region 2102 may be dynamic, for example, as blocks are encoded, the size and shape of IBC reference region 2102 may change.

In existing technologies, and in an example related to intra block copy (IBC), an IBC buffered cache region may comprise decoded samples of neighboring CTUs and a current CTU. In an example, reconstructed samples outside of an IBC reference region may be unavailable in an IBC buffer (also referred to as IBC buffered cache region) based on the samples being stored in an on-chip memory device. FIG. 21 further illustrates an example of when TMP search region 2108 exceeds the portions of IBC reference region 2102 available in the IBC buffer. For example, portions of region R2 outside the boundaries of IBC reference region 2102, to the left of and above the top-most row of CTUs of IBC reference region 2102, may be unavailable in an IBC buffer when the TMP search region 2108, comprising region R2, is based on a multiple of the TMP block size such as a multiple of 5 of the 64 samples (320 samples total), in a horizontal direction and a vertical direction. Because the portions of the TMP search region 2108 exceeding the portions of IBC reference region 2102 that are available in on-chip memory may need to be stored in off-chip memory, this may result in increased delay and reduced performance in reading and writing samples of these portions of TMP search region 2108.

Embodiments of the present disclosure are related to an approach for adjusting a template matching prediction (TMP) search region (also referred to as a TMP reference region) to be within an intra block copy (IBC) reference region. In an example, by adjusting the TMP search region to be within (or entirely within) the IBC reference region, the samples comprising the TMP search region may be stored in an on-chip memory device and avoid the need for additional off-chip memory when the boundaries of the TMP search region would otherwise exceed the boundaries of the IBC buffer (or IBC buffered cache region). In an example embodiment, a decoder may determine an adjusted template matching prediction (TMP) search region based on a size of a current block (CB) and an intra block copy (IBC) reference region, such that the adjusted TMP search region is within the IBC reference region. The decoder may further decode the CB based on a reference block (RB) within the adjusted TMP search region. In another example embodiment, a decoder may determine a template matching prediction (TMP) search region that is entirely within an intra block copy (IBC) reference region. The decoder may further decode a current block (CB) based on a reference block (RB) within the TMP search region. These and other features of the present disclosure are described further below.

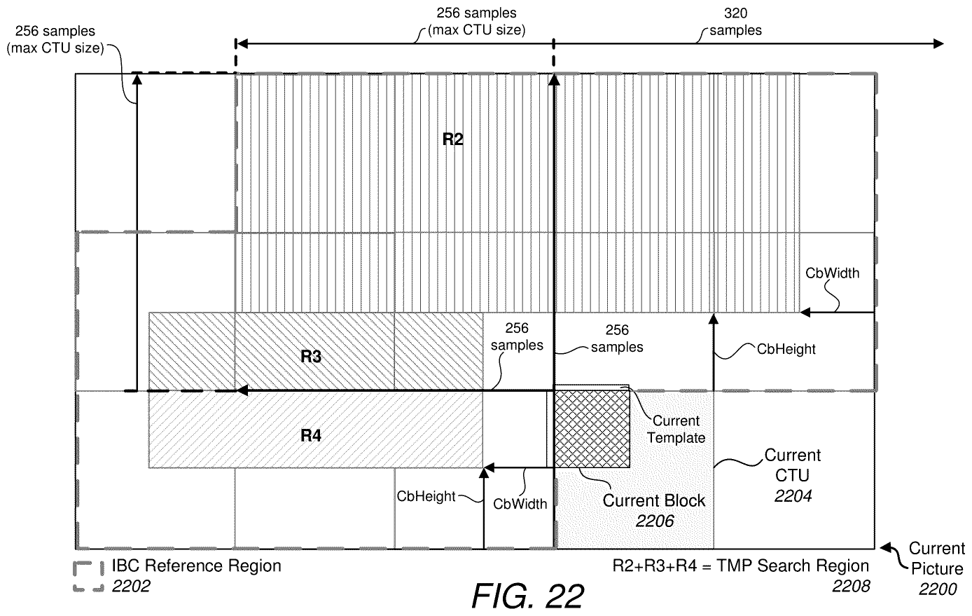

FIG. 22 illustrates an example adjusted template matching prediction (TMP) search region determined based on a size of a current block (CB) and an intra block copy (IBC) reference region in accordance with embodiments of the present disclosure. As illustrated in FIG. 22, current picture 2200 comprises a plurality of CTUs (indicated by squares) that are part of an IBC reference region 2202, wherein the boundaries of IBC reference region 2202 are indicated by dashed lines. Further, as illustrated in FIG. 22, IBC reference region 2202 comprises a plurality of columns and rows of samples relative to a current CTU 2204 including a current block 2206.

As discussed above, for TMP, the largest block size, such as a size of a current block or reference block, may be equal to 64×64 samples. Further, a TMP search region may be based on a multiple of the TMP block size. As illustrated in FIG. 22, a TMP search region 2208 may be based on a combination of regions denoted as R2, R3, and R4. Further, as illustrated in FIG. 22, the boundaries of region R2 are adjusted to be within IBC reference region 2202. For example, compared to FIG. 21, the top-most portion of region R2 of TMP search region 2208 exceeding a size of 256 samples in the vertical direction is adjusted to be within the top-most boundary of IBC reference region 2202. Further, compared to FIG. 21, the left-most portion of region R2 of TMP search region 2208 exceeding a size of 256 samples in the horizontal direction is adjusted to be within the left-most boundaries of IBC reference region 2202. In further examples, the adjusting may comprise aligning, constraining, or clipping the boundaries of TMP search region 2208 to the boundaries of IBC reference region 2202.

Further, as illustrated in FIG. 22, the right side of the R2 region is constrained to the right side of the boundary of current picture 2200. In other examples, more CTUs may be located to the right of current CTU 2204. Further, as illustrated in FIG. 22, the boundaries of the regions R2, R3, and R4 of TMP search region 2208 may be offset by a dimension of current block 2206 from the boundaries of IBC reference region 2202, such that the regions R2, R3, and R4 indicate boundaries for valid locations of TMP block vectors (BVs) indicating reference blocks for the current block. In an example, the dimension may be a width or a height of current block 2206. The rows and columns of available CTUs comprising IBC reference region 2202 may be dynamic, for example, as blocks are encoded, the size and shape of IBC reference region 2202 may change.

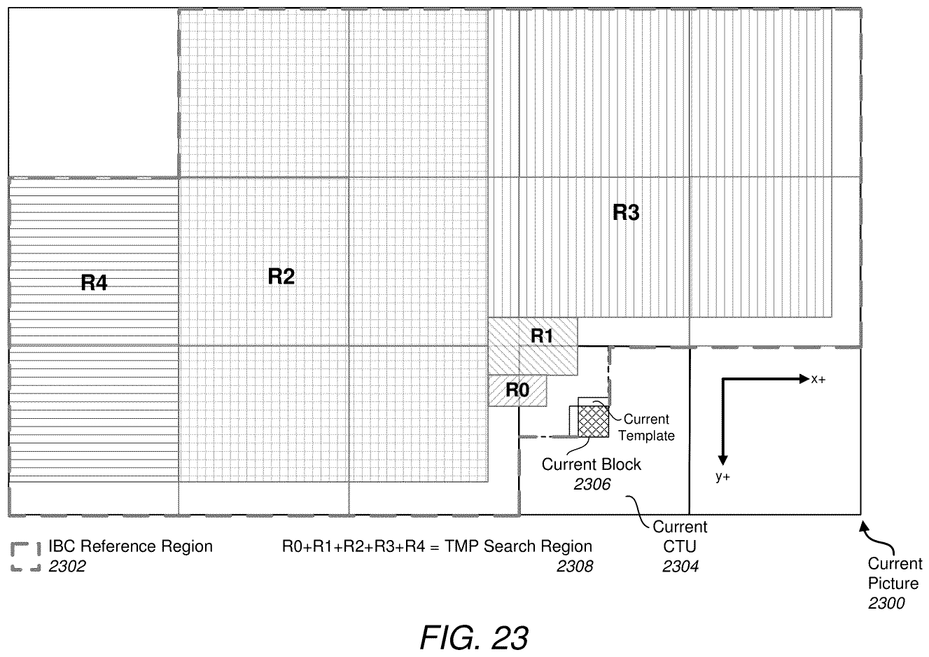

FIG. 23 illustrates another example adjusted TMP search region determined based on a size of a CB and an IBC reference region in accordance with embodiments of the present disclosure. As illustrated in FIG. 23, current picture 2300 comprises a plurality of CTUs (indicated by squares) that are part of an IBC reference region 2302, wherein the boundaries of IBC reference region 2302 are indicated by dashed lines. Further, as illustrated in FIG. 23, IBC reference region 2302 comprises a plurality of columns and rows of samples relative to a current CTU 2304 including a current block 2306.

As illustrated in FIG. 23, a TMP search region 2308 may be based on a combination of regions denoted as R0, R1, R2, R3, and R4. Compared to the example of FIG. 22, where the boundaries of region R2 are adjusted to be within an IBC reference region, in the example of FIG. 23, each of the regions R0, R1, R2, R3, and R4 are adjusted (e.g., aligned, constrained, or clipped) to be within IBC reference region 2308. In further examples, the adjusting may comprise aligning, constraining, or clipping the boundaries of TMP search region 2308 to the boundaries of IBC reference region 2302. Further, as illustrated in FIG. 23, the right side of the R3 region is constrained to the right side of the boundary of current picture 2300. In other examples, more CTUs may be located to the right of current CTU 2304. Further, as illustrated in FIG. 23, the boundaries of the regions R0, R1, R2, R3, and R4 of TMP search region 2308 may be offset by a dimension of current block 2306 from the boundaries of IBC reference region 2302, such that the regions R0, R1, R2, R3, and R4 indicate boundaries for valid locations of TMP block vectors (BVs) indicating reference blocks for the current block. In an example, the dimension may be a width or a height of current block 2306. The rows and columns of available CTUs comprising IBC reference region 2302 may be dynamic, for example, as blocks are encoded, the size and shape of IBC reference region 2302 may change.

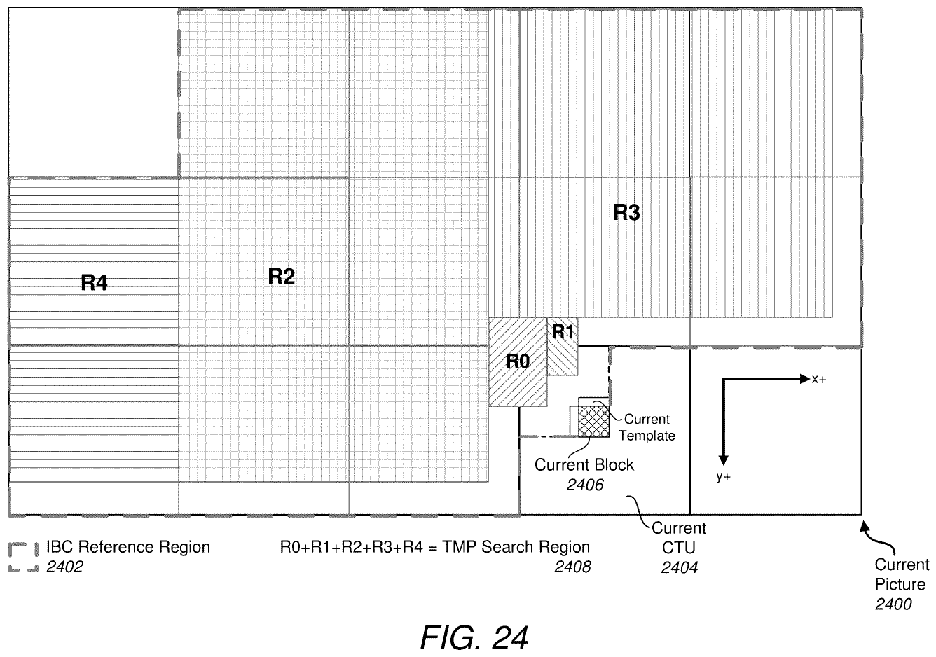

FIG. 24 illustrates another example of adjusted TMP search region determined based on a size of a CB and an IBC reference region in accordance with embodiments of the present disclosure. As illustrated in FIG. 24, current picture 2400 comprises a plurality of CTUs (indicated by squares) that are part of an IBC reference region 2402, wherein the boundaries of IBC reference region 2402 are indicated by dashed lines. Further, as illustrated in FIG. 24, IBC reference region 2402 comprises a plurality of columns and rows of samples relative to a current CTU 2404 including a current block 2406.

As illustrated in FIG. 24, a TMP search region 2408 may be based on a combination of regions denoted as R0, R1, R2, R3, and R4. Compared to the example of FIG. 22, where the boundaries of region R2 are adjusted (e.g., aligned, constrained, or clipped) to be within an IBC reference region, in the example of FIG. 24, each of the regions R0, R1, R2, R3, and R4 are adjusted to be within IBC reference region 2408. Further, compared to the example of FIG. 23, the locations of the regions R0 and R1 are modified, while the positions of the regions R2, R3, and R4 are unchanged. In further examples, the adjusting may comprise aligning, constraining, or clipping the boundaries of TMP search region 2408 to the boundaries of IBC reference region 2402. Further, as illustrated in FIG. 24, the boundaries of the regions R0, R1, R2, R3, and R4 of TMP search region 2408 may be offset by a dimension of current block 2406 from the boundaries of IBC reference region 2402, such that the regions R0, R1, R2, R3, and R4 indicate boundaries for valid locations of TMP block vectors (BVs) indicating reference blocks for the current block. In an example, the dimension may be a width or a height of current block 2406. The rows and columns of available CTUs comprising IBC reference region 2402 may be dynamic, for example, as blocks are encoded, the size and shape of IBC reference region 2402 may change.

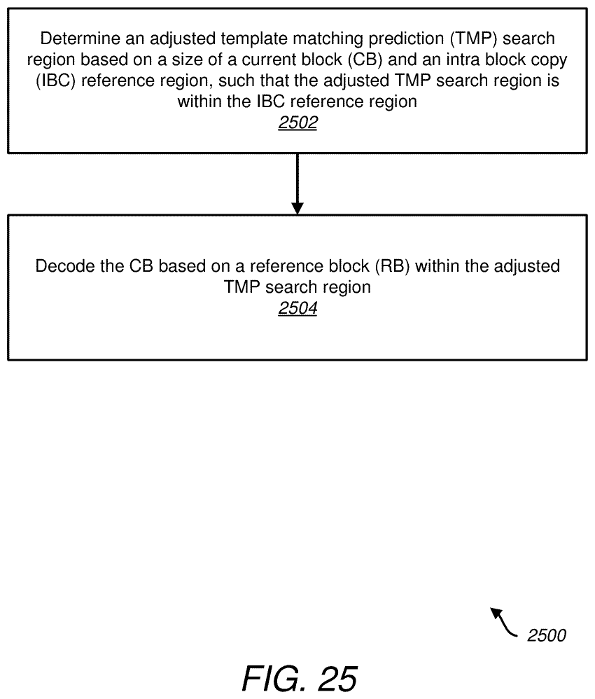

FIG. 25 illustrates a flowchart 2500 of a method for determining an adjusted template matching prediction (TMP) search region based on a size of a current block (CB) and an intra block copy (IBC) reference region in accordance with embodiments of the present disclosure. The method of flowchart 2500 may be implemented by a decoder, such as decoder 300 in FIG. 3. The method of flowchart 2500 begins at 2502.

At 2502, the decoder determines an adjusted template matching prediction (TMP) search region based on a size of a current block (CB) and an intra block copy (IBC) reference region, such that the adjusted TMP search region is within the IBC reference region. And, at 2504, the decoder decodes the CB based on a reference block (RB) within the adjusted TMP search region.

In an example, the determining the adjusted TMP search region may be further based on a multiple of the size of the CB. In an example, the multiple is 5 and the size of the CB is one of: 32, 64, 128, 256, 512, or 1024 pixels. In an example, the IBC reference region may be based on a maximum coding tree unit (CTU) size. In an example, the maximum CTU size may be one of 128, 256, or 512 pixels. In an example, the maximum CTU size may be based on a resolution of a video sequence. In an example, the IBC reference region may comprise decoded samples of neighboring CTUs and a current CTU stored in a memory device.

In an example, the determining the adjusted TMP search region based on the size of the CB and the IBC reference region may further include determining first boundaries of the TMP search region based on the size of the CB, determining second boundaries of the IBC reference region based on a maximum coding tree unit (CTU) size, and adjusting the first boundaries to be within the second boundaries. In an example, the IBC reference region may comprise a buffered cache region. In an example, the buffered cache region may comprise decoded samples of neighboring CTUs and a current CTU stored in a memory device. In an example, the adjusting may be further based on an upper boundary and a left boundary of the TMP search region. In another example, the adjusting may be further based on a maximum CTU size. In an example, the maximum CTU size may be one of 128, 256, or 512 pixels. In an example, the maximum CTU size may be based on a resolution of a video sequence.

In an example, the adjusting may comprise aligning the first boundaries with the second boundaries. In another example, the adjusting may comprise constraining the first boundaries to the second boundaries. In another example, the adjusting may comprise clipping the first boundaries to the second boundaries. In an example, prior to the adjusting, the TMP search region may comprise reconstructed samples unavailable in an intra block copy (IBC) buffered cache region based on the samples being stored in an on-chip memory device. In an example, the adjusting may further comprise defining a margin region of invalid locations for reference blocks (RBs) displaced from the CB by block vector (BV) candidates. In an example, the defining the margin region may be based on a height of the CB and a width of the CB.

In another example, the adjusted TMP search region may comprise a second region, a third region, and a fourth region. In an example, a top boundary of the third region may adjoin a bottom boundary of the second region. In an example, a top boundary of the fourth region may adjoin a bottom boundary of the third region. In an example, a right boundary of the third region may be above and left of the CB. In an example, the right boundary may be offset from the IBC reference region by a margin based on a dimension of the CB. In an example, the dimension of the CB may be a width of the CB or a height of the CB. In another example, a right boundary of the fourth region may be left of the CB. In an example, the right boundary may be offset from the IBC reference region by a margin based on a dimension of the CB. In an example, the dimension of the CB may be a width of the CB or a height of the CB.

In another example, the adjusted TMP search region may comprise: a first sub-region above and left of the CB; a second sub-region above and left of the CB having a top boundary adjoining a bottom boundary of the first sub-region; a third sub-region left of the first sub-region and the second sub-region; a fourth sub-region above the second sub-region; and a fifth sub-region left of the third sub-region. In an example, the adjusted first region may further comprise at least one of the first, second, third, fourth, and fifth sub-regions offset by a margin relative to the CB. In an example, the margin may be based on a height of the CB and a width of the CB.

In another example, the adjusted TMP search region may comprise: a first sub-region above and left of the CB; a second sub-region above and left of the CB having a left boundary adjoining a right boundary of the first sub-region; a third sub-region left of the first sub-region; a fourth sub-region above the first sub-region and the second sub-region; and a fifth sub-region left of the third sub-region. In an example, the adjusted first region may further comprise at least one of the first, second, third, fourth, and fifth sub-regions offset by a margin relative to the CB. In an example, the margin may be based on a height of the CB and a width of the CB.

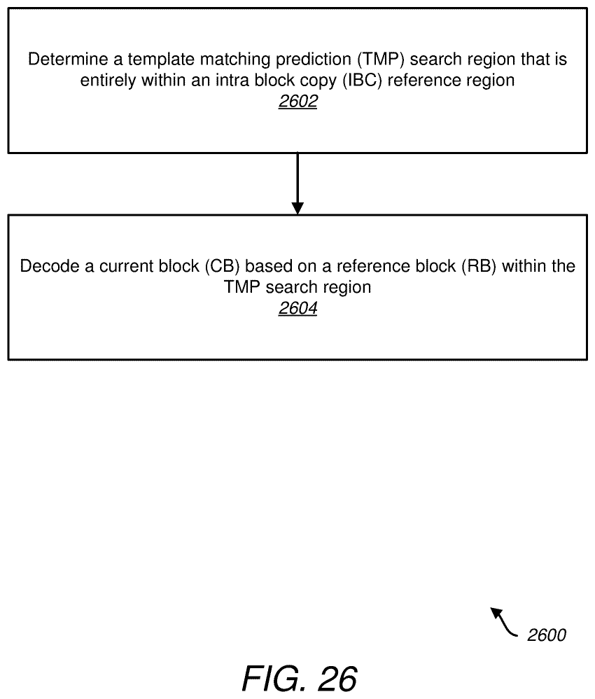

FIG. 26 illustrates a flowchart 2600 of a method for determining a template matching prediction (TMP) search region that is entirely within an intra block copy (IBC) reference region in accordance with embodiments of the present disclosure. The method of flowchart 2600 may be implemented by a decoder, such as decoder 300 in FIG. 3. The method of flowchart 2600 begins at 2602.

At 2602, the decoder determines a template matching prediction (TMP) search region that is entirely within an intra block copy (IBC) reference region. And, at 2604, the decoder decodes a current block (CB) based on a reference block (RB) within the TMP search region.

In an example, the determining the TMP search region that is entirely within the IBC reference region may further include determining first boundaries of the TMP search region based on a size of the CB, determining second boundaries of the IBC reference region based on a maximum coding tree unit (CTU) size, and adjusting the first boundaries to be entirely within the second boundaries. In an example, the IBC reference region may comprise a buffered cache region. In an example, the buffered cache region may comprise decoded samples of neighboring CTUs and a current CTU stored in a memory device. In an example, prior to the adjusting, the TMP search region may comprise reconstructed samples unavailable in an intra block copy (IBC) buffered cache region based on the samples being stored in an on-chip memory device. In an example, the adjusting may further comprise defining a margin region of invalid locations for reference blocks (RBs) displaced from the CB by block vector (BV) candidates. In an example, the defining the margin region may be based on a height of the CB and a width of the CB.

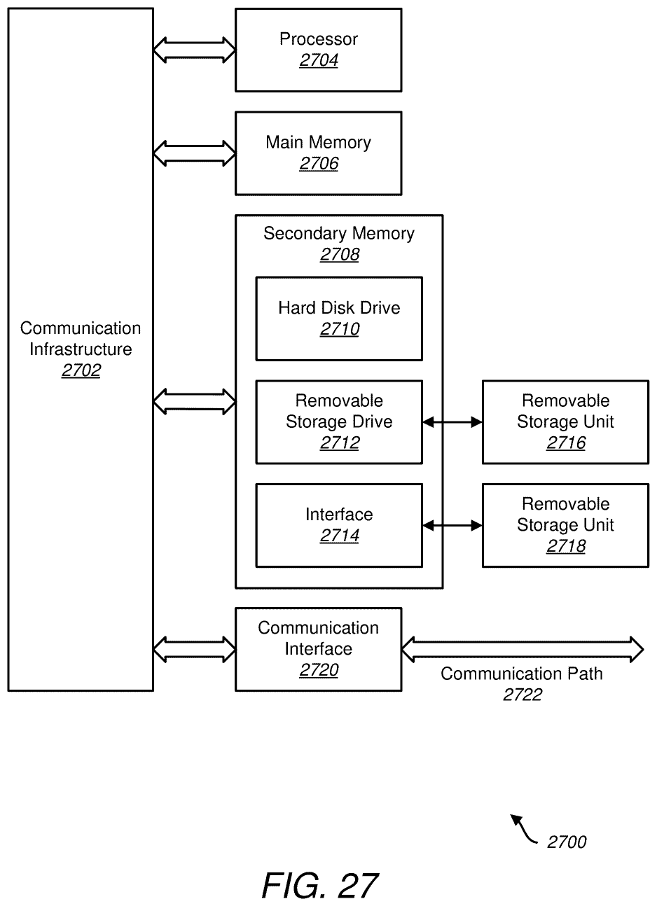

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2700 is shown in FIG. 27. Blocks depicted in the figures above, such as the blocks in FIGS. 1, 2, and 3, may execute on one or more computer systems 2700. Furthermore, each of the steps of the flowcharts depicted in this disclosure may be implemented on one or more computer systems 2700.

Computer system 2700 includes one or more processors, such as processor 2704. Processor 2704 may be, for example, a special purpose processor, general purpose processor, microprocessor, or digital signal processor. Processor 2704 may be connected to a communication infrastructure 2702 (for example, a bus or network). Computer system 2700 may also include a main memory 2706, such as random access memory (RAM), and may also include a secondary memory 2708.

Secondary memory 2708 may include, for example, a hard disk drive 2710 and/or a removable storage drive 2712, representing a magnetic tape drive, an optical disk drive, or the like. Removable storage drive 2712 may read from and/or write to a removable storage unit 2716 in a well-known manner. Removable storage unit 2716 represents a magnetic tape, optical disk, or the like, which is read by and written to by removable storage drive 2712. As will be appreciated by persons skilled in the relevant art(s), removable storage unit 2716 includes a computer usable storage medium having stored therein computer software and/or data.

In alternative implementations, secondary memory 2708 may include other similar means for allowing computer programs or other instructions to be loaded into computer system 2700. Such means may include, for example, a removable storage unit 2718 and an interface 2714. Examples of such means may include a program cartridge and cartridge interface (such as that found in video game devices), a removable memory chip (such as an EPROM or PROM) and associated socket, a thumb drive and USB port, and other removable storage units 2718 and interfaces 2714 which allow software and data to be transferred from removable storage unit 2718 to computer system 2700.

Computer system 2700 may also include a communications interface 2720. Communications interface 2720 allows software and data to be transferred between computer system 2700 and external devices. Examples of communications interface 2720 may include a modem, a network interface (such as an Ethernet card), a communications port, etc. Software and data transferred via communications interface 2720 are in the form of signals which may be electronic, electromagnetic, optical, or other signals capable of being received by communications interface 2720. These signals are provided to communications interface 2720 via a communications path 2722. Communications path 2722 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2716 and 2718 or a hard disk installed in hard disk drive 2710. These computer program products are means for providing software to computer system 2700. Computer programs (also called computer control logic) may be stored in main memory 2706 and/or secondary memory 2708. Computer programs may also be received via communications interface 2720. Such computer programs, when executed, enable the computer system 2700 to implement the present disclosure as discussed herein. In particular, the computer programs, when executed, enable processor 2704 to implement the processes of the present disclosure, such as any of the methods described herein. Accordingly, such computer programs represent controllers of the computer system 2700.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
setting all boundaries of a template matching prediction (TMP) search region to align with corresponding boundaries of an intra block copy (IBC) reference region; and
decoding the current block based on a reference block determined from the TMP search region.

2. The method of claim 1, wherein the IBC reference region comprises decoded samples of neighboring CTUs and of a current CTU stored in a memory device.

3. The method of claim 1, wherein the IBC reference region is based on a maximum coding tree unit (CTU) size.

4. The method of claim 1, wherein the setting comprises clipping an upper boundary or a left boundary of the TMP search region to a corresponding boundary of the IBC reference region.

5. The method of claim 1, wherein the TMP search region comprises a plurality of subregions, and wherein the setting comprises constraining one or more boundaries of at least one subregion of the plurality of subregions to a corresponding boundary of the IBC reference region.

6. The method of claim 5, wherein the at least one subregion has a rectangular shape.

7. The method of claim 1, wherein the setting further comprises defining a margin region of invalid locations for block vector (BV) candidates indicating reference blocks for the current block.

8. A decoder comprising:
one or more processors; and
memory storing instructions that, when executed by the one or more processors, cause the decoder to:
set all boundaries of a template matching prediction (TMP) search region to align with corresponding boundaries of an intra block copy (IBC) reference region; and
decode the current block based on a reference block determined from the TMP search region.

9. The decoder of claim 8, wherein the IBC reference region comprises decoded samples of neighboring CTUs and of a current CTU stored in a memory device.

10. The decoder of claim 8, wherein the IBC reference region is based on a maximum coding tree unit (CTU) size.

11. The decoder of claim 8, wherein the setting comprises clipping an upper boundary or a left boundary of the TMP search region to a corresponding boundary of the IBC reference region.

12. The decoder of claim 8, wherein the TMP search region comprises a plurality of subregions, and wherein the setting comprises constraining one or more boundaries of at least one subregion of the plurality of subregions to a corresponding boundary of the IBC reference region.

13. The decoder of claim 12, wherein the at least one subregion has a rectangular shape.

14. The decoder of claim 8, wherein the setting further comprises defining a margin region of invalid locations for block vector (BV) candidates indicating reference blocks for the current block.

15. A non-transitory computer-readable medium comprising instructions that, when executed by one or more processors of an apparatus, cause the apparatus to:
set all boundaries of a template matching prediction (TMP) search region to align with corresponding boundaries of an intra block copy (IBC) reference region; and
decode the current block based on a reference block determined from the TMP search region.

16. The non-transitory computer-readable medium of claim 15, wherein the IBC reference region comprises decoded samples of neighboring CTUs and of a current CTU stored in a memory device.

17. The non-transitory computer-readable medium of claim 15, wherein the IBC reference region is based on a maximum coding tree unit (CTU) size.

18. The non-transitory computer-readable medium of claim 15, wherein the setting comprises clipping an upper boundary or a left boundary of the TMP search region to a corresponding boundary of the IBC reference region.

19. The non-transitory computer-readable medium of claim 15, wherein the TMP search region comprises a plurality of subregions, and wherein the setting comprises constraining one or more boundaries of at least one subregion of the plurality of subregions to a corresponding boundary of the IBC reference region.

20. The non-transitory computer-readable medium of claim 19, wherein the at least one subregion has a rectangular shape.
